(19) United States
(12) Patent Application Publication
(10) Pub. No.: US 2007/0003204 A1
(43) Pub. Date: Jan. 4, 2007

(54) Methods and apparatus for splitter modules and splitter module housings

(76) Inventors: Elli Makrides-Saravanos, Highland Village, TX (US); Ziwei Liu, Ft. Worth, TX (US)

Correspondence Address: CORNING CABLE SYSTEMS LLC, P O BOX 489, HICKORY, NC, 28603, US

(21) Appl. No.: 11/171,609

(22) Filed: Jun. 30, 2005

(51) Int. Cl. G02B 6/00

(52) U.S. Cl. 385/135; 385/134

(57) ABSTRACT

Apparatus includes an optical splitter module including a housing, and an input optical fiber and an output optical fiber positioned with the housing, wherein at least one of the input and output optical fiber is partially potted.

### BACKGROUND OF THE INVENTION

1. Field of the Invention

The present invention relates generally to optical fiber modules and, more particularly, to methods and apparatus for optical splitter modules.

2. Description of the Related Art

Prior art 1×N optical splitter module designs typically consist of a large metal housing designed to accommodate a 1×32 (or 1×16) optical splitter and 33 (or 17) input/output connector assemblies. In these conventional modules, the splitter input and outputs are spliced to connectorized cable assemblies and, for this reason, conventional modules typically require a considerable amount of fiber space for fiber splicing and routing. These prior art splitter modules are time-consuming to assemble and thus are not desirable with respect to cost-effectiveness. Accordingly, there exists opportunities for improvement in optical splitter modules.

### BRIEF SUMMARY OF THE INVENTION

In one aspect, apparatus includes an optical splitter module including a housing, and an input optical fiber and an output optical fiber positioned with the housing, wherein at least one of the input and output optical fiber is partially potted.

In another aspect, apparatus includes an optical splitter module including a housing, and a tapered layer of potting compound within the housing.

In yet another aspect, a method includes placing at least one potting compound disk in a optical splitter module housing, and at least partially wrapping at least one optical fiber around the disk.

In still another aspect, a compound is provided. Wherein the compound includes an admixture of a Part A and a Part B, and wherein Part A includes Monodisperse SiO2 nanoparticles in vinyl-terminated polydimethyl siloxane (hereinafter “a1”) and Platinum Catalyst (0.5%, hereinafter “a2”), wherein proportions are (by weight) a1 being at least 99 parts, a2 being between 0.1 parts to 0.3 parts. Wherein Part B includes Monodisperse SiO2 nanoparticles in vinyl-terminated polydimethyl siloxane (hereinafter b1), Hydride terminated polydimethlysiloxane (hereinafter b2), and Polymethylhydrosiloxane (hereinafter b3), and wherein proportions are (by weight) b1 being between 50 parts and 65 parts, b2 being between 20 parts to 40 parts, and b3 being between 10 parts to 12 parts.

### BRIEF DESCRIPTION OF THE DRAWINGS

FIG. 1 illustrates a fiber layout inside a conventional splitter module.

FIG. 2 illustrates a schematic diagram of a splitter module in accordance with one embodiment of the invention.

FIG. 3 is a schematic view of one embodiment of a fanout holder.

FIG. 4 is a schematic section of one embodiment of a slotted fanout holder.

FIG. 5 is a schematic diagram of the splitter module incorporating a single fiber spool.

FIG. 6 is a schematic diagram of the splitter module incorporating four 8-fiber MTP connectors.

FIG. 7 illustrates a base and a cover that retains the fanout holder and strain relief boot in a sandwiched mode.

FIG. 8 illustrates the interaction between the base and the cover.

FIG. 9 illustrates the interaction between the base and the cover.

FIG. 10 illustrates that after the splitter is positioned inside the housing, a plurality of disks of cured silicone potting compound are positioned in pre-specified positions in the same housing.

FIG. 11 illustrates fibers that are then routed over an input silicone disk.

FIG. 12 illustrates that the routing shown in FIG. 11 allows a significant reduction in the length of the module by using the empty volume over the single fiber that is routed at the input.

FIG. 13 illustrates a partial potting of fibers.

FIG. 14 illustrates a module in its assembled state.

FIG. 15 illustrates that the fibers move out of the loose tube during temperature cycling and shrinkage of the loose tube.

FIG. 16 illustrates a fiber routing scheme diagrammatically.

FIG. 17 illustrates the same assembly of the splitter inside the module using a potting compound can be completed using removable fiber spool-guides as part of the tooling.

### DETAILED DESCRIPTION OF THE INVENTION

The present invention will now be described more fully hereinafter with reference to the accompanying drawings in which exemplary embodiments of the invention are shown. However, this invention may be embodied in many different forms and should not be construed as limited to the embodiments set forth herein. Like reference numbers refer to like elements throughout the various drawings.

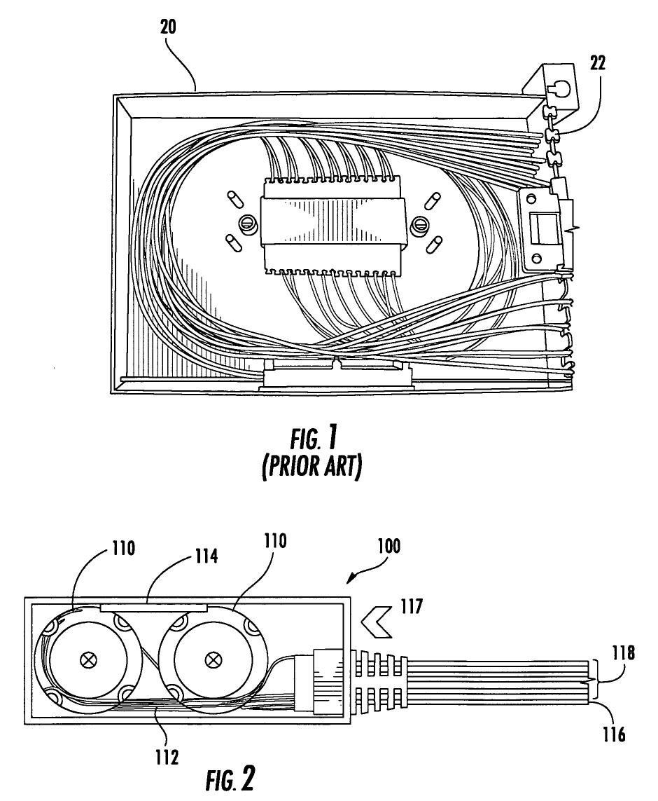

FIG. 1 illustrates a fiber layout inside a conventional splitter module 20. The known 1×N module design consists of a large metal housing designed to accommodate the 1×32 (or 1×16) optical splitter and the 33 (or 17) input/output connector assemblies. In module 20, the splitter input and outputs are spliced to connectorized cable assemblies and, for that reason, module 20 includes a relatively considerable amount of space for fiber splicing and routing. In addition, the fiber splicing and routing sometimes can be a cause of failures during assembly and/or qualification testing.

As shown in FIG. 1, the input and output pigtails are secured at the exit points from the module by utilizing Zero Epoxy Mechanical Attachment (Zema) connectors 22. Connectors 22 may account for almost half of the total cost of module 20.

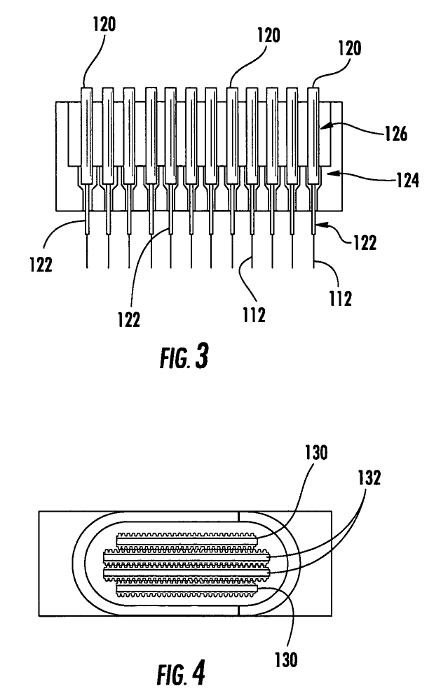

FIG. 2 illustrates a schematic diagram of a splitter module 100 incorporating at least one fiber spool 110 to facilitate controlling a bend radius of a plurality of fibers 112. In exemplary embodiments, a plurality of fiber spools are implemented to guide the fibers precisely to a controlled bend. A diagram of one fiber layout of the splitter module is shown in FIG. 2. The Zema connectors are eliminated and replaced by either a fanout holder or an MTP adaptor. As seen in FIG. 2, one embodiment employs two spools 110 inside module 100. The two spools accommodate length fluctuations of the fiber inside the module without causing tight bends due to movement restrictions. Also, the two spools facilitate a controlled routing for the input as well as the output fibers. The fibers are routed in a figure-8 configuration that separates them from a splitter body 114, thereby reducing the possibility of damage to the fibers by rubbing against the housing or getting pinched under splitter body 114. Other embodiments utilize a single spool 110 as described below. The herein described methods and apparatus facilitate a reduction in cost and an improvement in the performance and long-term reliability over conventional splitter module 20 by eliminating the splices and related fiber routing as well as the use of Zema connectors.

For example, one embodiment of module 100 may be assembled using a single fiber spool and allowing the input fiber to exit directly out of the module through the same fanout holder. In this embodiment, the input fiber is still threaded through a loose tube cable and through the same fanout holder. However, the loose tube is extended further to provide support for the input fiber. The loose tube is potted inside the silicone of the splitter tube. A different variation of this embodiment has the input fiber assembled with tight buffered fiber.

For the case of the fanout holder, the input and outputs are all accommodated through the same fanout holder, as shown in FIG. 2. The input fiber is color-coded for ease of identification (the tubes numbered 118 represent the output fibers and the tube numbered 116 represents the input fiber). The cable assemblies are bonded to the fanout holder by means of an adhesive and a softer potting compound such as silicone to provide additional strain relief.

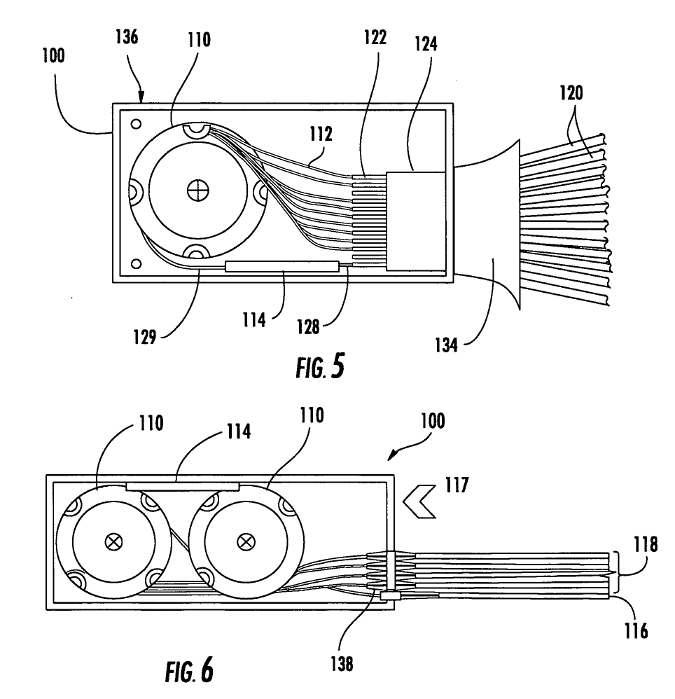

A lengthwise cross-section through the fanout holder is shown in FIG. 3. Shown in FIG. 3 are 2 millimeter (mm) or 1.6 mm cables 120 with loose tubes 122 and connectors (not shown). In one embodiment, the loose tubes are 900 micron tubes. Cables 120 are positioned in a fanout holder 124 and held with adhesive. A potting material 126 may be used to further maintain cables 120 in holder 124. Fibers 112 extend out tubes 122 into an interior of module as shown in FIG. 2. The fanout holder is designed so that it does not induce any loss increase to the fibers due to temperature fluctuations. As the temperature changes, the loose tube and the fiber expand and contract at different rates due to differences in the Coefficient of Thermal Expansion (CTE). The fiber inside the 900 micron tube is typically able to move unrestricted in order to avoid excess losses due to microbending. For that reason, in one embodiment, only the side of the 900 micron loose tube is bonded to the fanout, while its end remains open allowing the fiber to move unrestricted. FIG. 4 is a schematic section of the slotted fanout holder. FIG. 3 illustrates a fanout holder for a plurality of single fiber cables, while FIG. 4 illustrates a fanout holder for use with fiber optic ribbons. In the illustrated example of FIG. 4, an upper and a lower slot 130 are sized to receive an eight fiber ribbon, while the two middle slots 132 are sized to receive either a nine fiber ribbon or an eight fiber ribbon and another fiber. Accordingly, the two input fibers for a 2 by 32 splitter are routed in two middle slots 132 and all slots 130 and 132 have eights output fibers routed therethrough. In other embodiments, other configurations are used, such as slots with other than eight output fibers, such as twelve output fibers per slot, and/or a configuration where the inputs are on upper and lower slots 130 instead of middle slots 132.

FIG. 5 is a schematic diagram of a splitter module 100 incorporating a single fiber spool 110. The assembly of FIG. 5 is easy to manufacture since no fiber splicing or special routing is desired. Spool 110 allows for an easy placing of fibers with an appropriate bend radius. The assembly time of the illustrated unit is reduced by eliminating the splicing and fiber routing. Splitter 114 is connected to an input pigtail 128 and splits the inputted signal(s) to at least one ribbon 129 also connected to splitter 114. After separating the ribbons into individual 250-micron fibers, the fibers are threaded into the loose tube 2-mm cable (or loose tube 1.6-mm cable) that is already bonded to the fanout holder. The cable assemblies are then finished with the connector type that is requested by the customer. In both the embodiments shown in FIGS. 2 and 5, the input fibers and the output fibers pass through the same opening of the splitter housing. Utilizing the same fiber egress and ingress port for all input and output fibers results in a more environmentally robust splitter module than heretofore. FIG. 5 also illustrates that the cables 120 have a strain relief element 134 providing strain relief. Module 100, in one embodiment, includes a metal box 136 as a housing member.

If desired, any ribbon separation and the threading of the individual 250-micron fibers into the loose tube 2-mm cable can be done prior to the fabrication of the fiber array and assembly of the planar splitter. Additionally, individual fibers can be utilized and ribbonized for any desired portion of the routing path.

Another option is to peel optical fibers from the ribbon matrix after the splitter has been assembled and thread them through the loose tube of the fanout holder. During the peeling process it is possible that fiber will break, increasing the manufacturing scrap.

Due to the elimination of the fiber splicing and additional routing, module 100 that is herein described is approximately half the size of the module shown in FIG. 1 enabling a size reduction in the cabinet that houses the optical splitter modules.

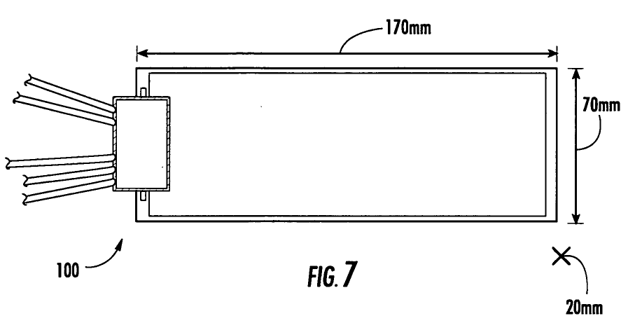

Another option is to replace the fan-out by an MTP adaptor. In this case, the fibers in the ribbons remain intact, and are terminated by four 8-fiber MTP connectors. A schematic diagram of this type of module is shown in FIG. 6. Note by locating the single access port toward a side of module 100, one can easily place a serial number on module 100. In addition to using an MTP connector, other known connectors could be used.

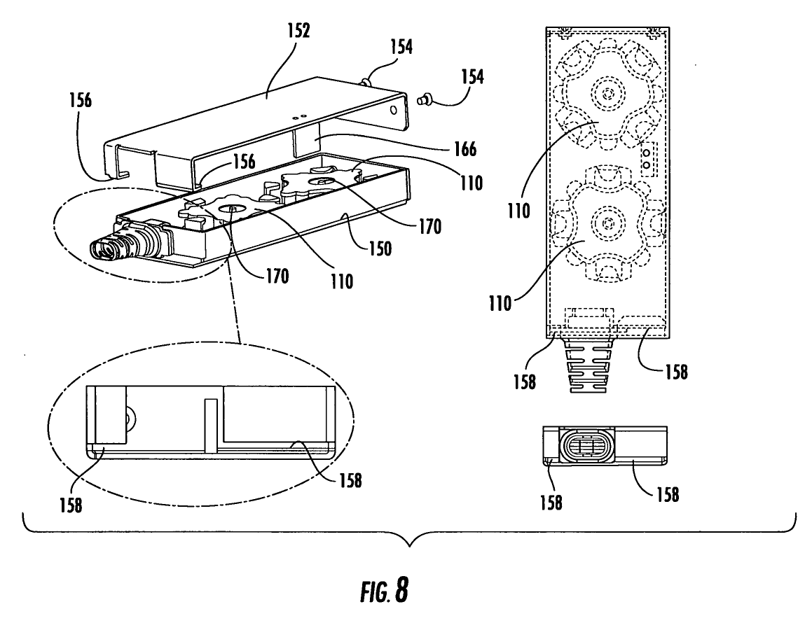

FIG. 6 is a schematic diagram of the splitter module incorporating four 8-fiber MTP connectors. The housing of the assemblies described above is specifically designed for simplicity and limited number of parts. A base and cover (more fully described below) are both functional and they are designed to work together to retain the fanout holder and strain relief boot in a sandwiched mode as shown in FIG. 7. This design allows the housing design to be very simple but also the mold for the fanout holder is also simple as a result. The base and cover are also designed to interlock at the front of the module allowing complete closure by two screws alone on the back end. In an exemplary embodiment, module 100 has a length of approximately 170 millimeters (mm), a width of approximately 70 mm and a depth of approximately 20 mm. In other embodiments, the length is between about 150 and 190 mm, the width is between about 50 and 90 mm, and the depth is between about 15 and 25 mm.

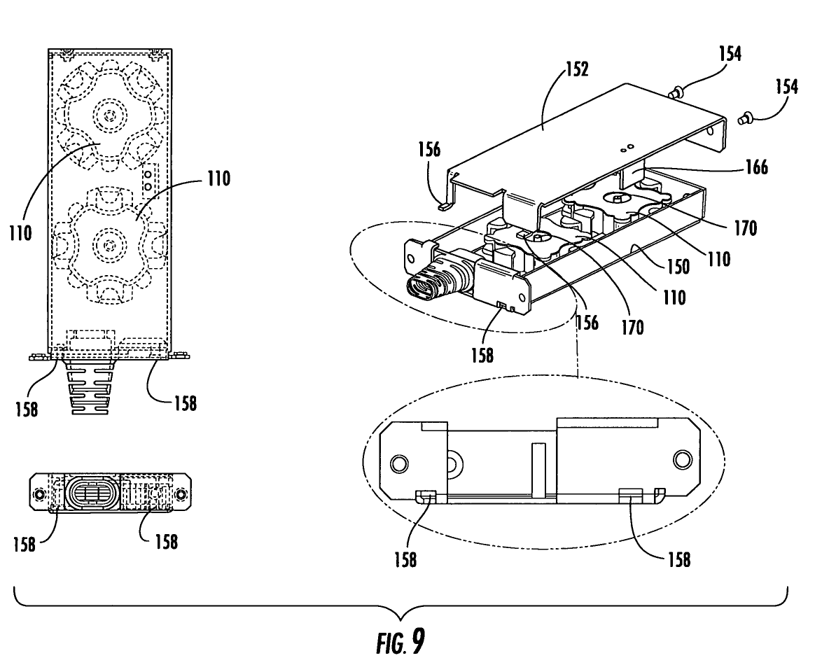

FIGS. 8 and 9 illustrate the cooperation between a base 150 and a cover 152 wherein at least one tongue 156 of cover 152 mates with at least one groove 158 of base 150 and at least one fastener 154 completes the assembly. In an exemplary embodiment, base 150 includes two grooves 158, cover 152 includes two tongues 156, and two screws 154 are used to fixedly attach cover 152 to base 150. A splitter shield 166 may be used to hold splitter 114 in a fixed location within base 150. Additionally, a resilient element (not shown) can be attached to shield 166 to reduce vibrations of splitter 114. Spools 110 are held in place by screws 170 that, in one embodiment, are welded to the bottom of base 150.

Technical effects of the herein described methods and apparatus include the fanout holder as previously described. This fanout holder may be preconnectorized wherever allowable by the splitter assembly. The packaging design of the fiber array-splitter-ferrule assembly inside a metal or plastic housing as shown in FIGS. 2 and 5 utilizing one or more fiber spools facilitates maintaining a desired bend diameter for the fibers. The input and outputs are accommodated inside a single fanout holder. Also the herein described methods and apparatus allow the input loose tube to extend to the splitter component housing and eliminate the need of a second spool and therefore achieve an additional size reduction as seen in FIG. 5. In one embodiment, the fibers are routed in a figure-8 configuration that separates them from the body of the splitter component. One embodiment replaces the 250 micron input of the splitter component with a 900 micron tight buffer fiber. This embodiment eliminates the desire for a second spool. One variation on this package design allows the implementation of the 8-fiber MTP adapter. Also, one can utilize splitters with bend insensitive fibers and reduce the size of the module even further. The strain relief boot is specifically designed for this module and it accommodates up to 34 cables for two 1 by 16 splitters or a 2 by 32 splitter.

Other configurations of the herein described methods and apparatus include varying the aspect ratio of the housing and allowing the fibers to exit the module on the wide dimension (side-loaded module). This allows the module to fit in cabinets as well as canisters.

The housing of the module is designed for a functional base as well as cover. The base and cover work together to retain the fanout holder and strain relief boot in a sandwiched mode keeping the design of all of the parts simpler to facilitate assembly.

The base and cover (each singularly and together termed “housing” as used herein) are also designed to interlock and to require only two screws to be secured together. The holding bracket 166 for the splitter is incorporated in the cover. This makes the assembly of the module simpler and faster by limiting the number of separate parts.

In one embodiment, no fiber spools are used and in the absence of fiber spools, a potting compound is used to fix the fibers in place. The potting compound in the exemplary embodiment is silicone but any material may be used as long as the material's chemistry does not damage the fiber coating or any of the other components of the splitter and/or the housing.

FIG. 10 illustrates that after the splitter 114 is positioned inside the housing, a plurality of disks 202 of cured silicone potting compound are positioned in pre-specified positions in the same housing. These disks have the desired diameter to meet the specifications of fiber bend loss. They are also very thin in height taking up a small volume inside the housing. The two silicone disks are shown in FIG. 10 as one dark and one light. In a different embodiment, the disks 202 are first dispensed and cured directly inside the base of the housing using proper tooling. The splitter 114 is then positioned correctly relative to the disks 202.

The fibers are then routed around the silicone disks 202 using a figure-8 configuration for the input and they are held above the housing (higher than the base of the housing) by using a fixture.

The entire base of the assembly is then potted with the same or similar potting compound, such as, for example, a silicone compound. The potting compound has a low viscosity to flow inside the housing, it covers the guide disks 202 and it is self-leveling. The silicone is then cured in an oven, or over a hot plate. It can also be formulated for a quick room temperature cure without external heat. A UV-curable material can also be used. It is contemplated that the benefits of the invention accrue to all potting material which is chemically stable with respect to any fiber coatings that are on the fibers. The potting compound is preferably relatively transparent, tough, fast curing, and has good adhesion to the substrate module housing. Some commercially available silicone potting compounds have had adhesion failures and are also expensive.

Therefore, a new silicone compound based on silicone nanotechnology has been developed. Results have shown that this formulation has superior mechanical and viscoelastic properties, and has good adhesion to the splitter module housing. In an exemplary embodiment, the silicone potting compound has two parts (Parts A and B) with an approximate 1:1 mixing ratio by weight. Wherein Part A is

Monodisperse SiO2 nanoparticles in vinyl-terminated polydimethyl siloxane (hereinafter “a1”);

Platinum Catalyst (0.5%, hereinafter “a2”); and

Sudan blue dye (optional, hereinafter “a3”).

Wherein proportions include (by weight) a1 being at least about 99 parts, (with about 99.7 parts being found especially advantageous), a2 being between about 0.1 parts to about 0.3 parts, (with about 0.3 parts being found especially advantageous), and Sudan blue dye being optional and at most being less than or equal to about 0.1 parts.

In one embodiment, the mixture of monodisperse SiO2 nanoparticles in vinyl-terminated polydimethyl siloxane is a preparation consisting of monodisperse, non-agglomerated, spherical SiO2 nanoparticles with an average diameter of 15 nm in vinyl functional polydimethyl siloxanes such as in the commercially available product named Nanocone, manufactured by hanse chemie based in Geesthacht near Hamburg Germany. Also in one embodiment, a2 is Catalyst 510 also available from hanse chemie.

Wherein Part B is:

Monodisperse SiO2 nanoparticles in vinyl-terminated polydimethyl siloxane (hereinafter b1);

Hydride terminated polydimethlysiloxane (hereinafter b2); and

Polymethylhydrosiloxane (hereinafter b3).

Wherein proportions include (by weight) b1 being between about 50 parts and about 65 parts, (with about 59 parts being found especially advantageous), b2 being between about 20 parts to about 40 parts, (with about 30 parts being found especially advantageous), and b3 being between about 10 parts to about 12 parts, (with about 12 parts being found especially advantageous).

In one embodiment, b1 is a preparation consisting of monodisperse, non-agglomerated, spherical SiO2 nanoparticles with an average diameter of 15 nm in vinyl functional polydimethyl siloxanes such as in the commercially available product named Nanocone, manufactured by hanse chemie based in Geesthacht near Hamburg Germany. Also in one embodiment, b2 is Silicone hydride M705 b3 is Silicone hydride C120 both also available from hanse chemie.

Mechanical and electric properties of this potting compound have been characterized. Results are listed in the table below.

| | |
|---|---|
| Sample | Name: SSP#5 |
| Base Chemistry | Silicone potting |
| Mix ratio | 1:1 |
| Pot life @ 25° C. | ˜9 min |
| Set time @ 25° C. | ˜15 min |
| Tensile Strength (Mpa) | 0.248 |
| Elongation (%) | ˜173 |
| Hardness (shore 00) | ˜53 |
| Dielectric Constant @ 27° C. | 2.784 |
| Ionic Conductivity @ 27° C. | undetectable |
| (pmho/cm) | |

The tensile test was performed with modified ASDM D638 method. 4″ tensile test bars were made by casting the SSP#5 silicone potting in a Teflon mold and cured more than 24 hours at room temperature to achieve best test specimen.

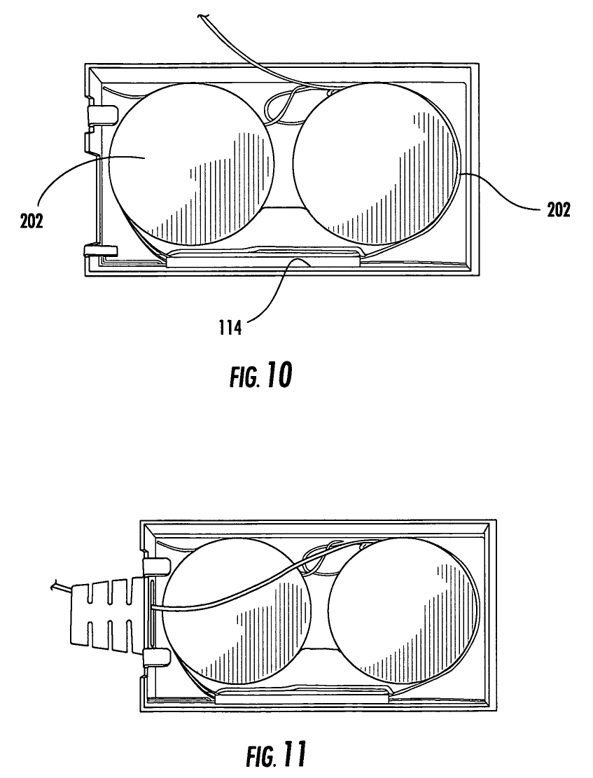

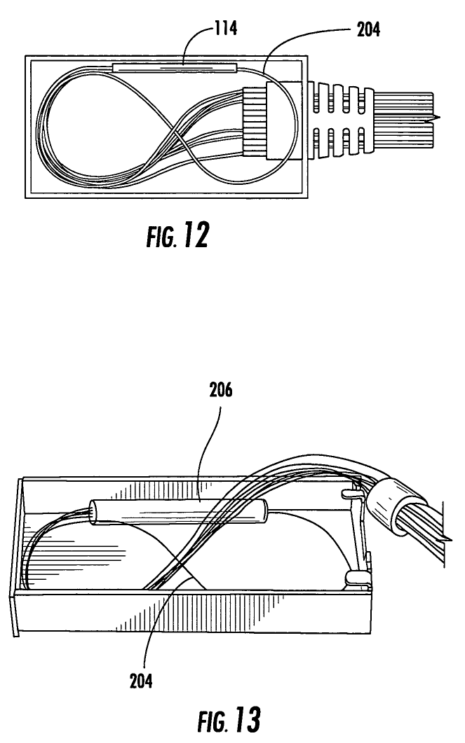

The fibers are then routed over the input silicone disk as shown in FIG. 11. This routing allows a significant reduction in the length of the module by using the empty volume over the single fiber that is routed at the input. This concept is shown in FIG. 12. In other words, an input fiber 204 is routed to the splitter 114 at a first elevation, and the output fibers 206 are routed to the splitter at a different elevation than the first. The bottom view of FIG. 12 best illustrates this 3-dimensional routing arrangement. During the potting process, the housing is tilted in relationship to the horizontal position. This allows a deeper silicone layer at the back of the module to allow the potting compound to cover the larger number of fibers routed from the output end of the splitter (32 outputs compared to one or two inputs). As illustrated in the lower view of FIG. 12, the silicone layer is tapered. And therefore the fibers are only partially potted as shown in FIG. 12. A sufficient length of fibers is left uncovered to allow for fiber movement due to temperature cycling of the loose tube.

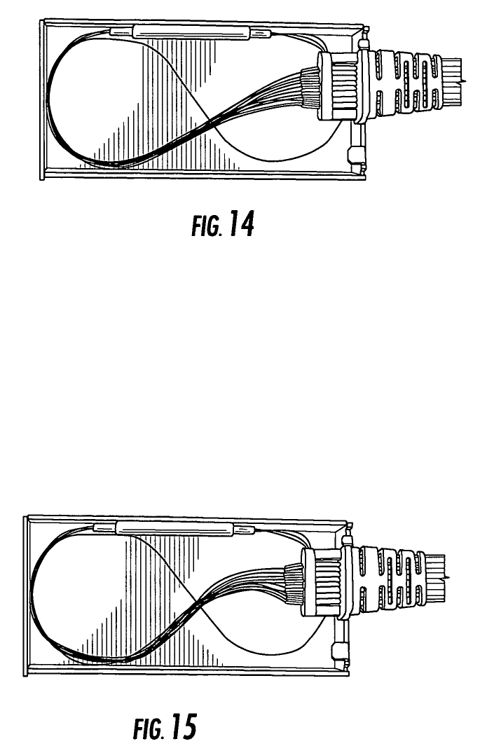

The partial potting of the fibers is also shown in FIG. 13. More particularly, an input fiber 204 is fully potted but a plurality of output fibers 206 are potted on a first side 208 and are unpotted on a second side 210. The fibers are then threaded through a loose-tube cable that is secured to a cable holder. To avoid confusion in distinguishing the input fiber 204 during the threading task, the input assembly uses a fiber color that is not the same as any of the colors that are used in the ribbon. In its assembled state, the module in shown in FIG. 14. As the fibers move out of the loose tube during temperature cycling and shrinkage of the loose tube, they are shown in FIG. 15.

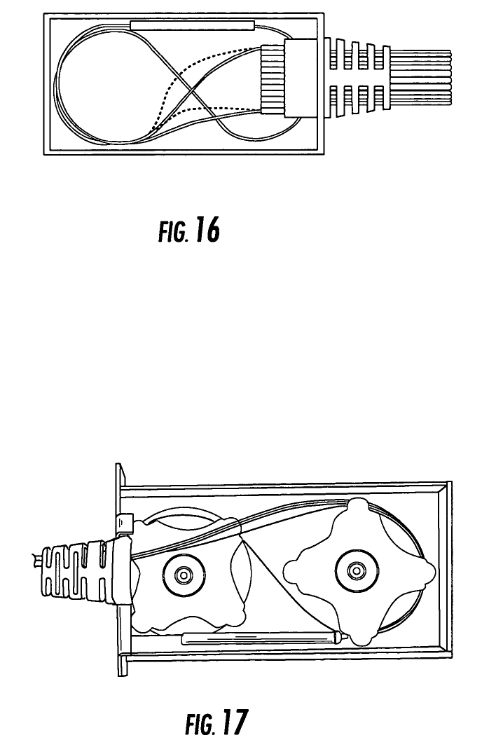

FIG. 16 illustrates a fiber routing scheme diagrammatically. The initial assembled position has an initial bend in it which forces the fibers to buckle in a preferred direction after temperature cycling. The fiber positions after the temperature cycling is shown with dotted lines while the fibers in their initial position are shown in solid lines. FIG. 17 illustrates the same assembly of the splitter inside the module using a potting compound can be completed using removable fiber spool-guides as part of the tooling. This was the process that was used in the packaging shown in FIG. 12 above. The outline of the fiber guides is visible in the above photographs.

The advantage of this packaging process is that the fibers are fixed in a layer of silicone in the base of the housing thus freeing the volume above it to be used for fiber routing and positioning of the cable holder reducing the volume of the module significantly.

The permanent guides of silicone may be replaced by permanently fixed fiber spools. In this case, the front spool can be very thin to accommodate the routing of the single input fiber. The cable holder can then be placed on top of the thin spool as shown in FIG. 17. The packaging design of fibers being fixed in place with potting compound to reduce the bulk volume of previously suggested hardware (fiber spools).

Technical effects include that the design concept of partially potted input and output fibers to allow space for fiber movement during temperature cycling. The fibers exit from the potting compound tangent to the output loop to meet the desired fiber bend diameter.

The fiber routing over the input fiber loop which creates an initial bend and subsequent direction for the buckled fibers. The placement of the cable holder over the input fiber loop enabling a significant reduction in the length of the module. The design concept of a very thin fiber spool for routing the input fiber and allowing the placement of the cable holder over it without increasing the thickness of the module. The input assembly uses a fiber color that is different from all the fiber colors that are used in the ribbon.

The herein described methods and apparatus provide for significantly lower cost by eliminating the fiber splicing (labor) and the Zema connector assemblies. Also an improved reliability due to elimination of fiber splicing and uncontrolled routing is also provided in one embodiment.

The herein described methods and apparatus also provide for a size reduction of the herein provided finished product compared to known designs for splitter modules. In accordance with one embodiment, the height of the module is utilized for fiber routing thus allowing its length to be reduced significantly.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

That which is claimed is:

1. Apparatus comprising:
an optical splitter module including a housing; and
an input optical fiber and an output optical fiber positioned with said housing, wherein at least one of said input and output optical fiber is partially potted.

2. The apparatus according to claim 1 further comprising at least one disk positioned within said housing.

3. The apparatus according to claim 2 wherein said input optical fiber is at least partially wrapped around said disk in a first direction and said output optical fiber is at least partially wrapped around said disk in a second direction different than said first direction.

4. The apparatus according to claim 1 wherein said partial potting is accomplished with a tapered silicone layer.

5. The apparatus according to claim 4 wherein said input fiber and said output fiber are at different elevations.

6. The apparatus according to claim 1 further comprising a fanout holder positioned in a surface of said housing.

7. The apparatus according to claim 6 wherein said fanout holder comprises slots of different sizes.

8. The apparatus according to claim 1 wherein said input fiber and said output fiber are at different elevations.

9. The apparatus according to claim 8 further comprising two silicone disks positioned within said housing.

10. The apparatus according to claim 1 wherein at least one of said input and output optical fiber is partially potted with a potting compound comprising:
an admixture of approximately equal portions by weight of a Part A and a Part B, wherein Part A comprises:
Monodisperse SiO2 nanoparticles in vinyl-terminated polydimethyl siloxane (hereinafter “a1”); and
Platinum Catalyst (hereinafter “a2”), wherein proportions are (by weight) a1 being at least 99 parts, a2 being between 0.1 parts to 0.3 parts; and
wherein Part B comprises:
Monodisperse SiO2 nanoparticles in vinyl-terminated polydimethyl siloxane (hereinafter b1);
Hydride terminated polydimethlysiloxane (hereinafter b2); and
Polymethylhydrosiloxane (hereinafter b3), wherein proportions are (by weight) b1 being between 50 parts and 65 parts, b2 being between 20 parts to 40 parts, and b3 being between 10 parts to 12 parts.

11. Apparatus comprising:
an optical splitter module including a housing; and
a tapered layer of potting compound within the housing.

12. The apparatus according to claim 11 further comprising a splitter body shield extending from said housing.

13. The apparatus according to claim 11 further comprising two potting compound disks positioned within said housing in the tapered layer.

14. The apparatus according to claim 13 wherein said potting compound disks comprise silicone disks.

15. A method comprising:
placing at least one potting compound disk in a optical splitter module housing; and
at least partially wrapping at least one optical fiber around the disk.

16. The method according to claim 15 further comprising partially potting the at least partially wrapped optical fiber.

17. The method according to claim 16 further comprising placing a plurality of optical fibers in the housing prior to said potting such that a 3-dimensional potted configuration is achieved.

18. The method according to claim 15 further comprising positioning an input optical fiber and an output optical fiber passing through a single opening in said housing.

19. The method according to claim 15 further comprising positioning an input optical fiber at least partially wrapped in a first direction and an output optical fiber at least partially wrapped in a second direction different from the first direction.

20. The method according to claim 15 further comprising a plurality of optical fibers arranged around a pair of potting compound disks in a figure 8 configuration.

21. A compound comprising:
an admixture of a Part A and a Part B, wherein Part A comprises:
Monodisperse SiO2 nanoparticles in vinyl-terminated polydimethyl siloxane (hereinafter “a1”); and
Platinum Catalyst (hereinafter “a2”), wherein proportions are (by weight) a1 being at least 99 parts, a2 being between 0.1 parts to 0.3 parts; and
wherein Part B comprises:
Monodisperse SiO2 nanoparticles in vinyl-terminated polydimethyl siloxane (hereinafter b1);
Hydride terminated polydimethlysiloxane (hereinafter b2); and
Polymethylhydrosiloxane (hereinafter b3), wherein proportions are (by weight) b1 being between 50 parts and 65 parts, b2 being between 20 parts to 40 parts, and b3 being between 10 parts to 12 parts.

22. The compound according to claim 21 wherein proportions for Part A are (by weight) a1 being 99.7 parts, a2 being 0.3 parts, and wherein proportions for Part B are b1 being 59 parts, b2 being 30 parts, and b3 being 12, and wherein the Platinum Catalyst is 0.5%.

23. The compound according to claim 21 wherein Part A includes Sudan blue dye.

24. The compound according to claim 21 wherein Part A includes Sudan blue dye in a proportion of no more than 0.1 parts.

25. The compound according to claim 21 wherein Part A and Part B are in equal quantities by weight.
